(19) United States
(12) Patent Application Publication
(10) Pub. No.: US 2007/0013502 A1
(43) Pub. Date: Jan. 18, 2007

(54) Apparatus for monitoring tire pressure using radio frequency identification system

(75) Inventors: Jun Seok Park, Seoul (KR); Ha Ryeng Oh, Goyang (KR); Jun O. Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: U-Comm Technology

(21) Appl. No.: 11/484,620

(22) Filed: Jul. 12, 2006

(30) Foreign Application Priority Data
Jul. 14, 2005 (KR) KR10-2005-0063890

(51) Int. Cl. B60C 23/00

(52) U.S. Cl. 340/447

(57) ABSTRACT

An apparatus for monitoring a tire pressure using a radio frequency identification system wherein a pressure and a temperature of a tire is constantly monitored for a driver to predict a dangerous situation that may occur in a future and to take a prompt action on the predicted dangerous situation is disclosed. The apparatus comprises a tag for measuring a pressure and a temperature of a tire installed on each of wheels, a reader for providing a power to the tag and for receiving and processing a pressure and temperature information provided by the reader, and a display device for receiving the processed pressure and temperature information and displaying the received pressure and temperature information.

### RELATED APPLICATIONS

The present disclosure relates to subject matter contained in priority Korean Application No. 10-2005-0063890 filed on 14 Jul. 2005, which is herein expressly incorporated by reference in its entirety.

### BACKGROUND OF THE INVENTION

1. Field of the Invention

The present invention relates to an apparatus for monitoring a tire pressure using a radio frequency identification system, and more particularly to an apparatus for monitoring a tire pressure using a radio frequency identification system wherein a pressure and a temperature of a tire is constantly monitored for a driver to predict a dangerous situation that may occur in a future and to take a prompt action on the predicted dangerous situation.

2. Description of the Related Art

In order to improve a safety during an operation of a vehicle, an apparatus for sensing a tire pressure has been proposed so that a driver in the vehicle may check a state of the tire of the vehicle (mainly the tire pressure) as an amount of traffic increases. A method for monitoring the pressure of the tire by the apparatus for sensing the state of the tire may be classified into an indirect measuring scheme utilizing a principle that a number of revolutions changes due to a difference in the pressure of the tire, and a direct measuring scheme wherein a pressure sensor is installed inside the tire.

While the indirect measuring scheme that utilizes the difference in the pressure of the tire is economical in a cost and an installing process, the indirect measuring scheme is disadvantageous in that an excessive measurement error is generated such that a false alarm is easily triggered, and is also disadvantageous in that only a relative comparison is possible and a complex device correction process is required.

The direct measuring scheme wherein the pressure sensor is installed inside the tire typically comprises transmitters installed in the tire for transmitting the state of the tire, and a receiver installed on a dash board of the vehicle for notifying the state of the tire to the driver. Each of the transmitters is installed at a wheel to measure the pressure of each of the tires, and each of the transmitters is battery-operated so that an operation is halted when a battery runs out.

Since the wheel should be detached from the tire in order to change the battery when the battery runs out, it is disadvantageous that the battery is difficult to be changed. Moreover, since the transmitter should be assembled with a high precision in order to last a rough state inside the tire, a reliability of the transmitter may be degraded when a case of the transmitter is opened.

### SUMMARY OF THE INVENTION

It is an object of the present invention to provide an apparatus for monitoring a tire pressure using a radio frequency identification system wherein a current status of a pressure and a temperature of a tire is received and displayed using a passive type sensor tag that does not include a battery and a reader to a dangerous situation that may occur in a future may be predicted and a prompt action on may be taken on the predicted dangerous situation.

In order to achieve the above-described object of the present invention, there is provided an apparatus for monitoring a tire pressure using an RFID system, the apparatus comprising: a passive type sensor tag for detecting a pressure and a temperature of a tire installed in each of wheels; a reader for providing a power to the passive type sensor tag and for processing a pressure and temperature information provided by the passive type sensor tag; and a display device for displaying the received pressure and temperature information after receiving the pressure and temperature information.

It is preferable that a communication between the reader and the display device comprises a wire communication, and the wire communication is carried out by a power line modem.

In addition, it is preferable that a communication between the reader and the display device comprises a wireless communication, the wireless communication is carried out by a bluetooth communication, and the bluetooth communication may utilize a frequency band of 2.45 GHz

### BRIEF DESCRIPTION OF THE DRAWINGS

FIG. 1 is a diagram illustrating an apparatus installed in a vehicle in accordance with an example of the present invention.

FIG. 2 is a block diagram illustrating an apparatus for monitoring a tire pressure using an RFID system in accordance with an example of the present invention.

FIG. 3 is a block diagram illustrating another example of a communication process between a reader and a display device of FIG. 1 in accordance with the present invention.

### DETAILED DESCRIPTION OF THE INVENTION

The present invention will now be described in detail with reference to the accompanied drawings.

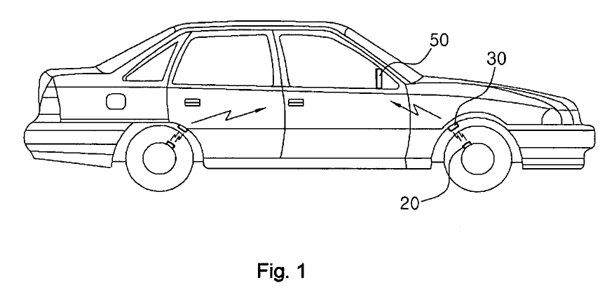

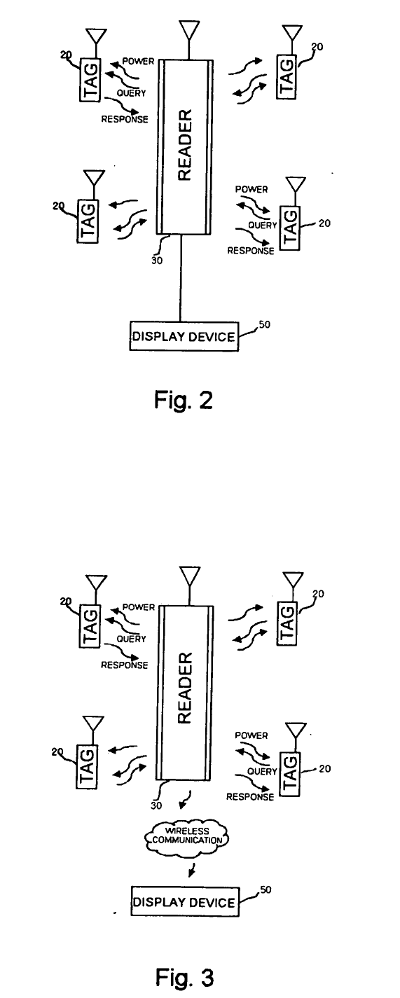

FIG. 1 illustrates an apparatus installed in a vehicle in accordance with the present invention, and FIG. 2 illustrates a basic structure of an apparatus for monitoring a tire pressure using an RFID system in accordance with the present invention.

Referring to FIGS. 1 and 2, the apparatus for monitoring a tire pressure comprises a passive type sensor tag 20 for detecting a pressure and a temperature of a tire 11 installed in each of wheels, a reader 30 for providing a power to the passive type sensor tag 20 and for receiving and processing a pressure and temperature information provided by the passive type sensor tag 20, and a display device 50 for displaying the received pressure and temperature information after receiving the pressure and temperature information.

The reader 30 transmits a radio frequency in a predetermined frequency band to the tag 20 and receives a frequency signal reflected from the tag 20. The reader 30 comprises an antenna and a transceiver for tranceiving the radio frequency, and a signal processor for processing the signal. The reader 30 is connected to the display device 50 including a controller, and the display device 50 analyzes, stores and displays the pressure and temperature information read out by the reader 30 using a predetermined application program.

A communication between the reader 30 and the display device 50 may comprise a wire communication, and the wire communication is carried out by a power line modem.

While the example wherein the communication between the reader 30 and the display device 50 may comprise wire communication is described, the communication may comprise a wireless communication. For instance, the wireless communication may be carried out by a bluetooth communication, and the bluetooth communication may utilize a frequency band of 2.45 GHz.

In accordance with the apparatus for monitoring the tire pressure using the RFID (Radio Frequency IDentification) system, the passive type sensor tag 20 should be activated in order to establish the communication between the reader 30 and the passive type sensor tag 20 since the passive type sensor tag 20 does not include any battery. That is, the reader 30 transmits a power to the passive type sensor tag 20 with a query signal. The reader 30 transmits the power and the query signal to the passive type sensor tag 20 via a scheme that utilizes a magnetic coupling formed between the reader 30 and the passive type sensor tag 20 using a multi-winding coil.

The passive type sensor tag 20 is activated using the power transmitted from the reader 30, and the passive type sensor tag 20 collects and temporarily stores the pressure and temperature information of the tire in a memory using a sensor of a built-in IC chip 25. The stored information is transmitted to the reader 30 through an RF (radio frequency) circuit and a control logic of the passive type sensor tag 20 when requested by the reader 30.

That is, the reader 30 transmits the query signal to the passive type sensor tag 20 using an RF signal fl. At this time, the reader 30 forms a query area having a predetermined size according to an output of the RF signal fl. The passive type sensor tag 20 in the query region of the reader 30, i.e. in the tire 11 receives the RF signal fl transmits a response signal including a unique identification information by receiving and reflecting the RF signal fl. The communication is established when a response region of the passive type sensor tag 20 overlaps the query region of the reader 30.

The pressure and temperature information received through the reader 30 is provided to the display device 50 via the wire communication. The display device 50 displays the received pressure and temperature information of the tire, and compares the pressure and temperature information of the tire to a predetermined reference value. The display device 50 then notifies a predicted dangerous state of the tire to the driver in a visual or an auditory manner.

As described above, in accordance with the apparatus for monitoring the tire pressure using the RFID system, the pressure and temperature information of the tire within a recognition range of the reader of the RFID system is received and displayed via the wire/wireless communication network so that the driver may predict a dangerous situation that may occur in a future and to take a prompt action on the predicted dangerous situation.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. An apparatus for monitoring a tire pressure using an RFID system, the apparatus comprising:
a passive type sensor tag for detecting a pressure and a temperature of a tire installed in each of wheels;
a reader for providing a power to the passive type sensor tag and for processing a pressure and temperature information provided by the passive type sensor tag; and
a display device for displaying the received pressure and temperature information after receiving the pressure and temperature information.

2. The apparatus in accordance with claim 1, wherein a communication between the reader and the display device comprises a wire communication.

3. The apparatus in accordance with claim 2, wherein the wire communication is carried out by a power line modem.

4. The apparatus in accordance with claim 1, wherein a communication between the reader and the display device comprises a wireless communication.

5. The apparatus in accordance with claim 4, wherein the wireless communication is carried out by a bluetooth communication.
